(19) United States
(12) Patent Application Publication
(10) Pub. No.: US 2024/0219754 A1
(43) Pub. Date: Jul. 4, 2024

(54) Optical Modulator and Digital Signal Processing Method

(71) Applicant: Nippon Telegraph and Telephone Corporation, Tokyo (JP)

(72) Inventors: Hiroshi Yamazaki, Musashino-shi, Tokyo (JP); Yoshihiro Ogiso, SR., Musashino-shi, Tokyo (JP); Toshikazu Hashimoto, Musashino-shi, Tokyo (JP)

(21) Appl. No.: 18/553,276

(22) PCT Filed: May 18, 2021
(86) PCT No.: PCT/JP2021/018849

§ 371 Date: Sep. 29, 2023

(51) Int. Cl. G02F 1/01

(52) U.S. Cl. CPC G02F 1/0121

(57) ABSTRACT

A novel configuration of an optical modulator is disclosed. The optical modulator includes: an input-side coupler that splits input light; an output-side coupler that couples a first optical path and a second optical path branched from the input-side coupler; a differential optical phase modulation unit that modulates phases of respective optical waves of the first optical path and the second optical path with a periodic signal having a frequency f_{c}; and a first IQ modulation unit arranged on the first optical path and a second IQ modulation unit arranged on the second optical path. The circuit configuration is simplified while achieving a bandwidth extension equivalent to that of an optical modulator by an optical time interleaving function of the related art, and size and loss reduction of the entire optical modulation circuit, relaxation of requirements of design and manufacturing processes, and cost reduction are achieved.

### TECHNICAL FIELD

The present invention relates to an optical modulation circuit and a signal processing method used for optical fiber communication.

### BACKGROUND ART

As represented by widespread use of smartphones, Internet traffic continues to increase every day, and optical fiber communication, wireless communication, wired telecommunication, and the like are required to have a large capacity and high functionality. Development of an efficient network configuration, an advanced digital modulation/demodulation system, an optical/electronic device capable of operating at a high speed, and the like has been continued as elemental technologies for increasing the capacity and functionality of a system. For example, focusing on a transmission side circuit of a communication device, a signal processing technology using a digital signal processor (DSP) which is a processor specialized in digital signal processing has been actively studied. A DSP enables processing such as advanced multi-level modulation and waveform shaping at a digital signal level.

In introducing a digital signal processing technology using a DSP, a digital-to-analog converter (DAC) capable of operating at a high speed, which converts a digital signal generated by the DSP into a final high-speed analog signal, is indispensable. However, DACs fabricated using current CMOS platforms have an insufficient analog output bandwidth of around 30 to 40 GHZ. The bandwidth shortage of the DAC has become one of bottlenecks in achieving a larger capacity of a communication system. As a technique for solving the bandwidth shortage of the DAC, Non Patent Literature 1 proposes an optical modulation circuit having an optical time interleaving function.

FIG. 1 is a diagram illustrating a configuration of an optical modulation circuit having an optical time interleaving function. An optical modulation circuit 100 is obtained by integrating an optical selector 190, a phase adjustment unit 151, IQ modulation units 161-1 and 161-2, and an output-side coupler 120. The optical selector 190 includes an input-side coupler 110 that splits input light 101 into two, a differential optical phase modulation unit 130, a phase adjustment unit 150, and a 2×2 coupler 180. The phase of the input light 101 split into two by the input-side coupler 110 is differentially modulated by two arm waveguides of the differential optical phase modulation unit 130. The phase adjustment unit 150 adjusts the relative optical phase between the two arm waveguides to the Quad point. The differential optical phase modulation unit 130 is driven by a periodic signal transmitted from a periodic signal source 140 to alternately transmit optical pulses to the two IQ modulation units 161-1 and 161-2 on the subsequent stage side.

The phase adjustment unit 151 for aligning the optical phases of the optical pulse trains alternately transmitted from the optical selector 190 is provided between the optical selector 190 and the IQ modulation units 161-1 and 161-2. Outputs from the IQ modulation units 161-1 and 161-2 are multiplexed by the output-side coupler 120 and transmitted as an output signal 102 of the optical modulation circuit 100.

In the optical modulation circuit 100 of FIG. 1, an optical time interleaving operation of separately modulating the alternating optical pulse train from the optical selector 190 by the two IQ modulation units 161-1 and 161-2 is performed. Optical time interleaving makes it possible to transmit a large amount of information as compared with a case where the IQ modulation units 161-1 and 161-2 are used alone. For example, the optical selector 190 is driven at a frequency B, and the IQ modulation units 161-1 and 161-2 are each modulated with a single carrier signal having a symbol rate B. When the timing of each optical pulse train from the optical selector 190 is matched with the timing of the modulation symbol to the IQ modulation unit, a single carrier signal having a symbol rate 2B can be generated.

By alternately distributing the symbols received on the receiver side from the optical signal 102 modulated by the optical modulation circuit 100, the signals modulated by the IQ modulation units 161-1 and 161-2 can be separated. Since a spectrum of the optical signal subjected to the optical time interleaving has about twice the bandwidth of a spectrum of the original optical signal, the optical time interleaving can also be regarded as a technology of extending the bandwidth to about twice and achieving a large capacity.

As described above, the optical modulation circuit 100 provides an about twice the bandwidth extension function, but the waveform of the modulated optical signal obtained as the output of the optical modulation circuit 100 cannot be arbitrarily controlled only by simply driving the two IQ modulation units with independent signals. In Non Patent Literature 1, an optical transmitter using both the optical modulation circuit 100 and digital spectrum folding is used to enable generation of an arbitrary waveform in an extended bandwidth.

The digital spectrum folding in Non Patent Literature 1 is equivalent to signal processing in a signal generation device using an analog multiplexer disclosed in Patent Literature 1. The signal generation device of Patent Literature 1 can generate a signal having an arbitrary waveform in a band up to about twice the analog bandwidth of a sub-DAC. The function of the optical selector 190 in the optical modulation circuit 100 of FIG. 1 corresponds to the function of the analog multiplexer in the signal generation device of Patent Literature 1. Therefore, by using the digital spectrum folding to generate drive signals of the IQ modulation units 161-1 and 161-2 in FIG. 1, it is possible to generate an optical signal having an arbitrary waveform in a band up to about twice that of the case where the IQ modulation units 161-1 and 161-2 are used alone.

### CITATION LIST

### Patent Literature

Patent Literature 1: WO 2017/033446 A

### Non Patent Literature

Non Patent Literature 1: H. Yamazaki et al., “Extension of Transmitter Bandwidth Using Optical Time-Interleaving Modulator and Digital Spectral Weaver,” J. Lightw. Technol., vol. 39, no 4, pp. 1132-1137, February 2021

### SUMMARY OF INVENTION

### Technical Problem

However, the optical time-interleaved optical modulator of the related art has a problem that an optical circuit configuration is complicated. From the viewpoint of reduction in size and reduction in optical loss of a device such as an optical transmitter, it is desirable to minimize the number of components of an optical circuit.

The present invention has been made in view of such a problem, and an object of the present invention is to provide an optical modulation circuit having a wider band with a simpler optical circuit configuration than that in the related art.

### Solution to Problem

One aspect of the present invention relates to an optical modulation circuit including: an input-side coupler that splits input light; an output-side coupler that couples a first optical path and a second optical path branched from the input-side coupler; a differential optical phase modulation unit that modulates phases of respective optical waves of the first optical path and the second optical path with a periodic signal having a frequency f_{c}; and a first IQ modulation unit arranged on the first optical path and a second IQ modulation unit arranged on the second optical path.

Another aspect of the present invention relates to an optical modulation circuit including: an input-side coupler that splits input light; a differential optical phase modulation unit that differentially modulates a phase of each optical wave from the input-side coupler with a periodic signal having a frequency f_{c}; a first coupler that splits a first modulated optical wave of the differential optical phase modulation unit; a second coupler that splits a second modulated optical wave of the differential optical phase modulation unit; a first sub-optical modulation circuit to which one split light from the first coupler and one split light from the second coupler are input; a second sub-optical modulation circuit to which the other split light from the first coupler and the other split light from the second coupler are input; and an orthogonal polarization coupler that couples the first sub-optical modulation circuit and the second sub-optical modulation circuit.

Still another aspect of the present invention relates to a signal processing method used in a receiver that receives a transmission signal from an optical transmitter including the optical modulation circuit described above, the signal processing method including: a step of dividing a received complex signal having a bandwidth less than 4f_{c} around a carrier frequency on a frequency axis into four bands approximately for each width f_{c}; a step of generating four digital divided signals corresponding to signals obtained by frequency-shifting a spectrum of the divided bands to baseband (0 to +f_{c}); and a step of calculating complex signal spectra X₁(f) and X₂(f) provided by one IQ modulation unit or one sub-IQ modulation unit based on the following three formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.

$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$

$${X}_{1} ( f ) = {X}_{1 -} ( f + {f}_{c} ) + {X}_{1 +} ( f )$$

$${X}_{2} ( f ) = {X}_{2 -} ( f + {f}_{c} ) + {X}_{2 +} ( f )$$

### Advantageous Effects of Invention

As described above, according to the present invention, bandwidth extension about twice that in a case where the IQ modulation unit is used alone is achieved as in the related art, with a simpler optical circuit configuration than that in the related art. Furthermore, it is also possible to provide an optical transmitter capable of generating an arbitrary waveform in an extended bandwidth.

### BRIEF DESCRIPTION OF DRAWINGS

FIG. 1 is a diagram illustrating an optical modulation circuit having an optical time interleaving function.

FIG. 2 is a diagram schematically illustrating a configuration of an optical modulation circuit of a first embodiment.

FIG. 3 is a diagram illustrating a spectrum of an output optical signal of the optical modulation circuit of the first embodiment.

FIG. 4 is a diagram illustrating a relationship between components obtained by decomposing a reception optical signal Z(f) into narrow bands.

FIG. 5 is a diagram schematically illustrating a configuration of an optical modulation circuit of a second embodiment.

FIG. 6 is a diagram schematically illustrating a configuration of an optical modulation circuit of a third embodiment.

FIG. 7 is a diagram schematically illustrating a configuration of an optical modulation circuit according to a fourth embodiment.

FIG. 8 is a diagram schematically illustrating a configuration of an optical modulation circuit according to a fifth embodiment.

### DESCRIPTION OF EMBODIMENTS

The optical modulation circuit of the present disclosure provides an optical modulation circuit that achieves bandwidth extension about twice that in a case where the IQ modulation unit is used alone, with a simpler optical circuit configuration than that in the related art. The circuit configuration is simplified while achieving a bandwidth extension equivalent to that of an optical modulator by an optical time interleaving function of the related art, and it is possible to reduce the size and loss of the entire optical modulation circuit, and to relax requirements of design and manufacturing processes, thereby achieving cost reduction. The signal processing in the optical modulation circuit of the present disclosure also has an aspect as a method of generating an arbitrary optical modulation waveform in the optical modulation circuit or a method of demodulating a modulated optical signal generated by the optical modulation circuit. Either method can process a signal extended to about twice the bandwidth of a single IQ modulation unit included in the optical modulation circuit or reception circuit.

In the following description of the present specification, the analog bandwidth of the DAC refers to an upper limit frequency of an analog g signal that can be output by the DAC without particularly large signal deterioration. Specifically, the frequency at which the intensity of the output analog signal from the DAC attenuates by a certain value compared to the vicinity of DC is often set as the analog bandwidth of the DAC. A decrease amount of the signal intensity defining the analog bandwidth of the DAC is arbitrarily set according to the spectrum shape of the signal to be generated, the characteristics of the transmission/reception device, and the like. Typically, a decrease amount of about 3 to 6 dB with respect to the signal intensity near DC and a decrease amount of about 20 dB at the maximum are used as threshold values to define the analog bandwidth of the DAC.

In addition, in the following description of the present specification, as a material for forming the optical modulation circuit, for example, a multicomponent oxide crystal such as LiNbO₃ (LN) having the Pockels effect, which is a kind of electro-optic (EO) effect, or a GaAs-based or InP-based compound semiconductor capable of refractive index modulation by the Pockels effect and a quantum confined Stark effect (QCSE) can be used. Furthermore, a Si or SiGe semiconductor having a pn junction capable of refractive index modulation by a carrier plasma effect, a polymer having an EO effect such as a chromophore, or the like can also be used. The optical modulation circuit of the present disclosure below has novel features in its circuit configuration, and the effect of the invention does not depend on the material forming the circuit.

Hereinafter, first, a configuration of an optical modulation circuit of the present disclosure in which the optical modulation circuit of the related art is simplified and a principle of a convolution process for extending a bandwidth will be described. Further, a variation form of the optical modulation circuit having the basic configuration will be described.

### First Embodiment

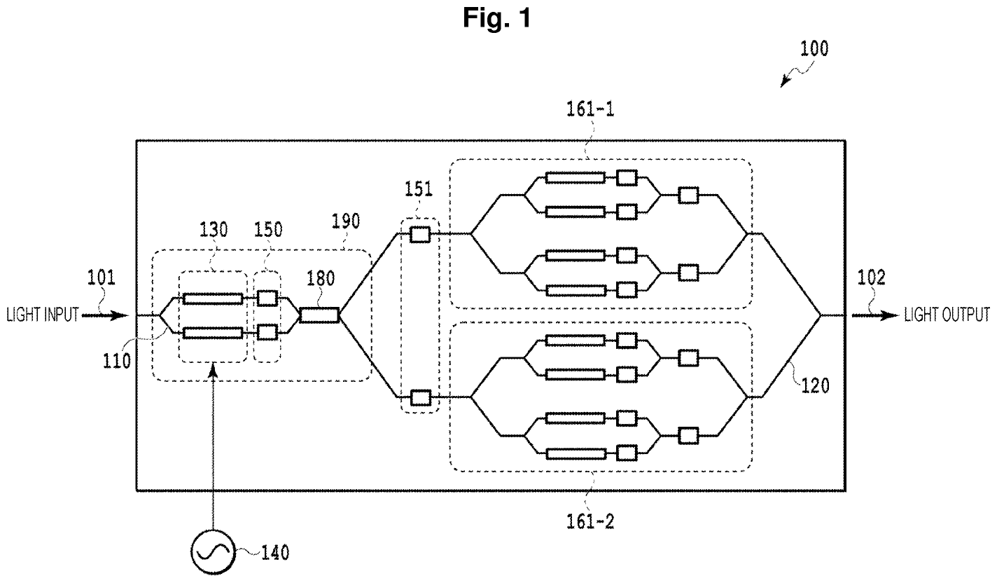

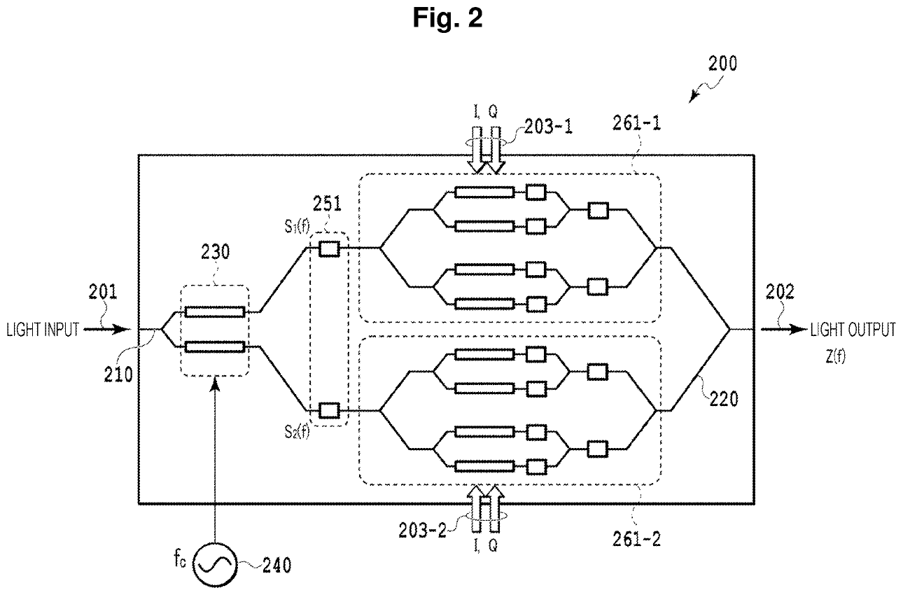

FIG. 2 is a diagram schematically illustrating a configuration of an optical modulation circuit of a first embodiment. An optical modulation circuit 200 is obtained by integrating an input-side coupler 210, a differential optical phase modulation unit 230, a phase adjustment unit 251, IQ modulation units 261-1 and 261-2, and an output-side coupler 220. The overall configuration of the optical modulation circuit 200 is substantially the same as that of the optical modulation circuit 100 having an optical time interleaving function of the related art illustrated in FIG. 1, but is simplified as described later. First, a difference from the configuration of the optical modulation circuit in FIG. 1 will be described.

The phase of input light 201 split into two by the input-side coupler 210 is differentially modulated by two arm waveguides of the differential optical phase modulation unit 230, but is driven by a sine wave signal having a frequency f_{c} emitted from a periodic signal source 240 unlike the optical modulation circuit of the related art in FIG. 1. In the optical modulation circuit 100 by optical time interleaving in FIG. 1, alternate pulses are supplied to the two IQ modulation units on the subsequent stage side. On the other hand, the differential optical phase modulation unit 230 of the optical modulation circuit 200 of the present disclosure applies phase modulation of opposite signs to two internal optical paths. Since the split input light 201 is subjected to phase modulation by the sine wave signal, continuous light having a modulation phase with opposite polarity and a constant intensity is supplied to each of the two IQ modulation units 261-1 and 261-2 on the subsequent stage. As the differential optical phase modulation unit 230, the same structure as a phase modulation arm of a push-pull Mach-Zehnder modulator which is a component of a general optical IQ modulator can be used.

When the entire optical modulation circuit 200 is viewed, the optical path lengths of the two optical paths including each IQ modulation unit are the same. That is, an optical path length difference between an optical path from the input-side coupler 210 to the output-side coupler 220 via the differential optical phase modulation unit 230 and the IQ modulation unit 261-1 and an optical path from the input-side coupler 210 to the output-side coupler 220 via the differential optical phase modulation unit 230 and the IQ modulation unit 262-2 is zero. As will be described later, by modulating the two IQ modulation units with independent information signals 203-1 and 203-2, it is possible to perform modulation with a signal of a band that is twice the bandwidth possible with a single IQ modulation unit. The optical modulation circuit 200 is a single polarization modulation circuit not having a polarization multiplexing function using one input light beam 201 as a carrier.

Therefore, the optical modulation circuit of the present disclosure can be implemented as an optical modulation circuit including: the input-side coupler 210 that splits the input light 201; the output-side coupler 220 that couples a first optical path and a second optical path branched from the input-side coupler; the differential optical phase modulation unit 230 that modulates phases of respective optical waves of the first optical path and the second optical path with a periodic signal having a frequency f_{c}; and the first IQ modulation unit 261-1 arranged on the first optical path and the second IQ modulation unit 261-2 arranged on the second optical path.

In the present embodiment, the phase-modulated optical wave from the differential optical phase modulation unit is applied to the first IQ modulation unit and the first IQ modulation unit.

As compared with the optical modulation circuit 100 having an optical time interleaving function of the related art illustrated in FIG. 1, the optical modulation circuit 200 has a more simplified configuration in which portions corresponding to the 2×2 coupler 180 and the phase adjustment unit 150 are omitted. By reducing the number of circuit elements to be integrated as compared with the configuration of the related art in FIG. 1, it is possible to reduce the size and loss of the entire optical modulation circuit.

For example, since the phase adjustment unit 150 in the differential optical phase modulation unit in FIG. 1 is unnecessary, the number of control points for phase adjustment is reduced by one, and thus the related wiring and the control mechanism are also simplified. The optical modulation circuit 200 includes the phase adjustment unit 251 corresponding to the phase adjustment unit 151 in the optical modulation circuit of the related art illustrated in FIG. 1, and the phase adjustment unit 251 is provided to align the optical phases of the above-described two optical paths. Since the compensation of the optical phase difference between the two optical paths can also be performed by changing the phase of the complex signal that drives the IQ modulation unit, the phase adjustment unit 251 can be omitted. In the phase adjustment unit 151 of the optical modulation circuit 100 of the related art, the phase adjustment unit 151 can be similarly omitted. However, in the optical modulation circuit 100 of the related art, the phase adjustment unit 150 in the phase adjustment unit is essential for alternately transmitting the optical pulses from the optical selector 190, and cannot be omitted.

In addition, the elimination of the 2×2 coupler 180 in the optical modulation circuit 200 of the present disclosure is also advantageous in that the accuracy in the manufacturing process of the optical circuit can be relaxed. Generally, the 2×2 coupler is implemented in a form of a multimode interference (MMI) coupler, a directional coupler, or the like. Coupling/splitting ratios, which are important performance parameters of MMI couplers and directional couplers, have wavelength dependence and are also sensitive to manufacturing errors. For this reason, in order to stably manufacture an object operating over a wide wavelength band, an advanced design technology and a manufacturing technology are required. Since the optical modulator circuit 200 of the present embodiment does not require a 2×2 coupler, it is easier to design and manufacture as compared with the optical modulation circuit 100 of the related art, and improvement in yield can be expected. In this way, the optical modulation circuit of the present embodiment is simplified by omitting some components as compared with the configuration of the related art, and it is possible to achieve reduction in overall size and loss of the optical modulation circuit and relaxation of conditions of design and manufacturing processes.

Since the 2×2 coupler is omitted in the present optical modulation circuit 200, what is transmitted from the differential optical phase modulation unit 230 to the IQ modulation units 261-1 and 261-2 is a constant intensity optical wave phase-modulated with a sine wave signal having a frequency f_{c}. As described above, in the optical modulation circuit 100 of the related art, alternate optical pulse trains on the time axis are supplied to the two IQ modulation units. Therefore, the optical modulation circuit 200 does not provide the optical time interleaving function itself. However, as will be described in detail below, also in the optical modulation circuit 200, the bandwidth can be extended to about twice by continuous light having a modulation phase with opposite polarity and a constant intensity and the spectrum folding operation, similarly to the optical time interleaving.

The IQ modulation units 261-1 and 261-2 are driven by two analog electrical signals 203-1 and 203-2 corresponding to an in-phase (I) component and a quadrature-phase (Q) component, respectively. Spectra of the analog electrical signal that drives the IQ modulation unit 261-1 is denoted by X_{1I}(f) and X_{1Q}(f), and spectra of the analog electrical signal that drives the IQ modulation unit 261-2 is denoted by X_{2I}(f) and X_{2Q}(f). In the IQ modulation units 261-1 and 261-2, spectra X₁(f) and X₂(f) of modulation signals applied to the input optical wave by modulation using the analog drive signal can be expressed as spectra of complex signals as follows.

$$\begin{matrix}[ Math . 1 ] & \\ {X}_{1} ( f ) = {X}_{1 I} ( f ) + {jX}_{1 Q} ( f ) & Formula ( 1 a )\end{matrix}$$

$${X}_{2} ( f ) = {X}_{2 I} ( f ) + {jX}_{2 Q} ( f ) \qquad Formula ( 1 b )$$

The spectrum of the final output optical signal 202 of the optical modulation circuit 200 is expressed as a spectrum of a complex signal in which an optical carrier component is omitted, and is denoted by Z(f). The spectra of the optical waves transmitted from the differential optical phase modulation unit 230 to the IQ modulation units 261-1 and 261-2 are similarly expressed as spectra of complex signals in which optical carrier components are omitted, and are denoted by S₁(f) and S₂(f), respectively. The spectrum of the output complex signal from the IQ modulation unit 261-1 is represented by a convolution of X₁(f) and S₁(f), and the spectrum of the output complex signal from the IQ modulation unit 261-2 is represented by a convolution of X₂(f) and S₂(f). The two convolutional outputs are coupled by the output-side coupler 220, and Z(f), which is the spectrum of the output optical signal 202, is expressed by the following formula.

$$\begin{matrix}[ Math . 2 ] & \\ z ( f ) = {X}_{1} ( f ) * {S}_{2} ( f ) + {X}_{2} ( f ) * {S}_{2} ( f ) & Formula ( 2 )\end{matrix}$$

In the spectrum Z(f) of the output optical signal of the optical modulation circuit 200 of Formula (2), the operational symbol * represents convolution. As described above, S₁(f) and S₂(f) are outputs from the differential optical phase modulation unit 230 in a case where the driving is performed by the sine wave signal of the frequency f_{c}. The spectrum has respective components (0, ±f_{c}, ±2f_{c}, ±3f_{c}, . . . ) at an optical carrier frequency, f_{c}, and harmonics thereof. Among these frequency components, the phase of the even-order component (0, ±2f_{c}, . . . ) is in phase between S₁(f) and S₂(f), and the phase of the odd-order component (±f_{c}, ±3f_{c}, . . . ) is in opposite phase between S₁(f) and S₂(f) (phase difference π). Specifically, the outputs S₁(f) and S₂(f) of the differential optical phase modulation unit can be expressed by the following formulae.

$$\begin{matrix}[ Math . 3 ] & \\ {S}_{1} ( f ) = {J}_{0} ( α ) + {J}_{1} ( α ) \{ δ ( f - {f}_{c} ) - δ ( f + {f}_{c} ) \} + {J}_{2} ( α ) \{ δ ( f - 2 {f}_{c} ) + δ ( f + 2 {f}_{c} ) \} + {J}_{3} ( α ) \{ δ ( f - 3 {f}_{c} ) - δ ( f + 3 {f}_{c} ) \} + … & Formula ( 3 a )\end{matrix}$$

$${S}_{2} ( f ) = {J}_{0} ( α ) - {J}_{1} ( α ) \{ δ ( f - {f}_{c} ) - δ ( f + {f}_{c} ) \} + {J}_{2} ( α ) \{ δ ( f - 2 {f}_{c} ) + δ ( f + 2 {f}_{c} ) \} - {J}_{3} ( α ) \{ δ ( f - 3 {f}_{c} ) - δ ( f + 3 {f}_{c} ) \} + … \qquad Formula ( 3 b )$$

In Formulae (3a) and (3b), Jₖ is a Bessel function of the first kind with order k, and δ is a Dirac delta function. Further, α is a parameter representing the drive amplitude. The voltage that gives an inter-arm phase difference π in the differential optical phase modulation unit 230 is called a half wavelength voltage V_{π}, and when the voltage amplitude (peak-to-peak) of the driving sine wave is Vₚₚ, α=πVₚₚ/(4V_{π}). For example, when the differential optical phase modulation unit 230 is driven with an amplitude such that the inter-arm phase difference becomes −π to +π, α=0.5 n. Here, the voltage value of V_{π} or Vₚₚ described above is defined by a differential voltage, that is, a voltage difference between both arms in a case where the differential optical phase modulation unit 230 is differentially driven. Normally, driving is performed under a condition of α=about 0.2π to 1.0π.

From Formulae (2), (3a), and (3b), the following formula is derived as the spectrum Z(f) of the output optical signal 202.

$$\begin{matrix}[ Math . 4 ] & \\ Z ( f ) = {J}_{0} ( α ) \{ {X}_{1} ( f ) + {X}_{2} ( f ) \} + {J}_{1} ( α ) \{ {X}_{1} ( f - {f}_{c} ) - {X}_{2} ( f - {f}_{c} ) - {X}_{1} ( f + {f}_{c} ) + {X}_{2} ( f + {f}_{c} ) \} + {J}_{2} ( α ) \{ {X}_{1} ( f - 2 {f}_{c} ) + {X}_{2} ( f - 2 {f}_{c} ) + {X}_{1} ( f + 2 {f}_{c} ) + {X}_{2} ( f + 2 {f}_{c} ) \} + {J}_{3} ( α ) \{ {X}_{1} ( f - 3 {f}_{c} ) - {X}_{2} ( f - 3 {f}_{c} ) - {X}_{1} ( f - 3 {f}_{c} ) + {X}_{2} ( f + 3 {f}_{c} ) \} + … & Formula ( 4 )\end{matrix}$$

The first term of Formula (4) corresponds to a fundamental wave component of X₁(f) and X₂(f), the second term corresponds to a ±first-order image of X₁(f) and X₂(f), and the third term corresponds to a ±second-order image of X₁(f) and X₂(f). The relationship between the information signals 203-1 and 203-2 to the two IQ modulation units of the optical modulation circuit 200, that is, the drive signals X_{1I}(f), X_{1Q}(f), X_{2I}(f), and X_{2Q}(f) and the final output optical signal Z(f) has been obtained from the above Formulae (1) to (4).

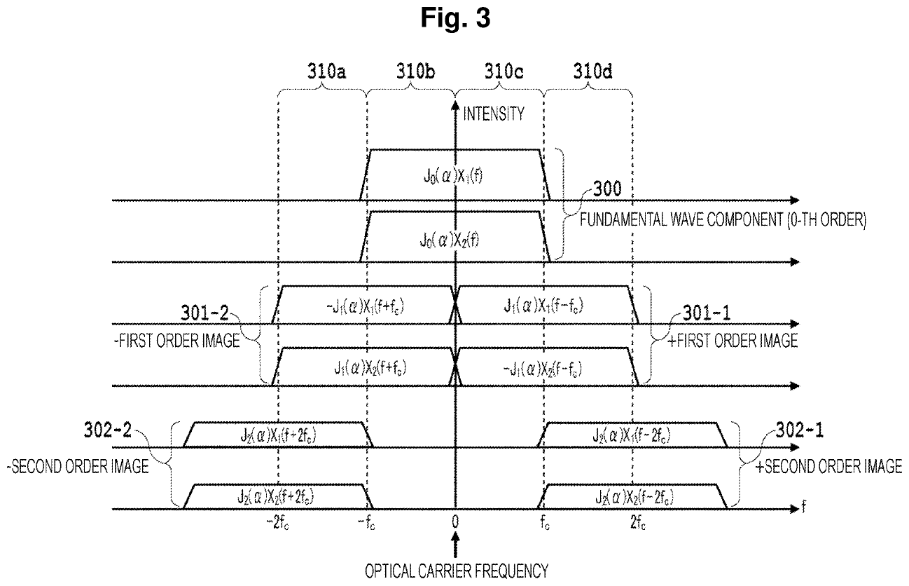

FIG. 3 is a diagram illustrating a spectrum of the output optical signal 202 from the optical modulation circuit 200 expressed by Formula (4). In FIG. 3, fundamental wave components 300 of X₁(f) and X₂(f) in the first term of Formula (4) are illustrated in the range of frequencies −f_{c} to +f_{c}. ±first-order image components 301-1 and 301-2 of X₁(f) and X₂(f) in the second term of Formula (4) are illustrated in the range of frequencies −2f_{c} to +2f_{c}. #secondary image components 302-1 and 302-2 of X₁(f) and X₂(f) in the third term of Formula (4) are illustrated in the ranges of frequencies −3f_{c} to −f_{c} and +f_{c} to +3f_{c}.

The drive signals X_{1I}(f), X_{1Q}(f), X_{2I}(f), and X_{2Q}(f) to the two IQ modulation units are baseband real signals. Assuming that the band of these real signals is B, as illustrated in the spectrum 300 of FIG. 3, the band of the complex signals X₁(f) and X₂(f) are 2B including both side wavebands. Therefore, in a case where one of the IQ modulation units 261-1 and 261-2 is used alone, the band of the output optical signal is 2B. As described above, B is the band of the drive signal to the IQ modulation unit, and is limited by the band characteristics of the drive system, for example, the band characteristics of the DAC that generates the drive signal and the band characteristics of the driver amplifier that amplifies the drive signal.

In the optical modulation circuit 200 of the present disclosure, the drive frequency f_{c} of the differential optical phase modulation unit 230 is set to be about the same as the band B of the drive signal (real signal) to the IQ modulation unit. By setting the band of the drive signal to the IQ modulation unit and the drive frequency f_{c} of the differential optical phase modulation unit to about the same, the final output optical signal Z(f) becomes a signal in which two fundamental waves or images of X₁(f) and X₂(f) overlap each other for each frequency width f_{c}. Referring again to FIG. 3, in a band 310a of the frequencies −2f_{c} to −f_{c}, two −first order images and two −second order images overlap each other. In a band 310b of the frequencies −f_{c} to 0, two fundamental waves and two −first order images overlap each other. Similarly, two fundamental waves and two +first-order images overlap in a band 310c of the frequencies 0 to +f_{c}, and two +first-order images and two +secondary images overlap each other in a band 310d of the frequencies +f_{c} to +2f_{c}.

In the optical modulation circuit 200 of the present disclosure, components of a band 4f_{c} centered on the frequency zero (carrier) in the spectrum of Z(f), that is, components of the bands 310a to 310d of 4B of the frequencies −2f_{c} to +2f_{c} are used for information transmission. The band of 4B corresponds to about twice the band 2B of the output optical signal in a case where the IQ modulation units 261-1 and 261-2 are used alone. Since the information transmission is performed using independently the two IQ modulation units to which the real signal of the band B (corresponding to the upper limit frequency of the DAC) is supplied, it should be possible to transmit the same amount of information without loss by using the spectrum of the band 4B in the output optical signal Z(f). However, the optical signals from the two IQ modulation units are mixed and cannot be separated by simply modulating and combining the two IQ modulation units with independent information.

In the optical modulation circuit 200, the drive frequency f_{c} of the differential optical phase modulation unit is set to be about the same as the band B of the drive signal to the IQ modulation unit, and appropriate signal processing is performed on the reception side, so that the information of X₁(f) and X₂(f) can be separated, similarly to the optical time interleaving of the related art. By using the two IQ modulation units in parallel, it is possible to achieve transmission of information of about twice the bandwidth as compared with a complex spectrum 2B obtained by the IQ modulation unit by the real signal from the DAC of the band B. Similarly to the optical time interleaving function, the optical modulation circuit 200 of the present disclosure solves the problem of the bandwidth shortage of the DAC, and at the same time, achieves a simpler configuration than that in the related art. Hereinafter, it is indicated that the information of the complex signals X₁(f) and X₂(f) of the modulation signal can be separated from the components of the frequencies −2f_{c} to +2f_{c} in the output optical signal Z(f) of the optical modulation circuit 200 of the present disclosure.

First, for the band of 4B of the received optical signal Z(f), frequency components of approximately −2f_{c} to −f_{c} (band 310a), −f_{c} to 0 (band 310b), 0 to +f_{c} (band 310c), and +f_{c} to +2f_{c} (band 310d) are frequency-shifted to baseband. Specifically, the component of −2f_{c} to −f_{c} (band 310a) is frequency-shifted in the positive direction by +2f_{c} after being cut out from Z(f) to obtain Z_{H-}(f). The component of −f_{c} to 0 (band 310b) is frequency-shifted in the positive direction by +f_{c} after being cut out from Z(f) to obtain Z_{L-}(f). The component having the frequency of approximately 0 to +f_{c} (band 310c) is cut out from Z(f) and left as Z_{L+}(f) as it is. The component of +f_{c} to +2f_{c} (band 310d) is frequency-shifted in the negative direction by −f_{c} after being cut out from Z(f) to obtain Z_{H+}(f). That is, the frequency shift to the baseband means that each component in the four bands in the band 4B of the frequencies −2f_{c} to +2f_{c} is cut out and shifted into the band 310c of the frequencies 0 to +f_{c}. The above-described processing is performed, for example, as calculation processing of the DSP in the digital domain for the band of 4B of the received optical signal Z(f). It can be understood that, in the processing including the above-described frequency shift, the signal of the band 4B of the received optical signal Z(f) is expressed by a signal obtained by decomposing the signal of the band 4B into respective components of four bands of the band B, converting the components into the signal of the band B having an upper limit of about f_{c}, and decomposing and shifting the signal.

In addition, positive frequency components of complex drive signals X₁(f) and X₂(f) to the two IQ modulation units are expressed as X₁₊(f) and X₂₊(f), respectively, and negative frequency components of X₁(f) and X₂(f) frequency-shifted by +f_{c} are expressed as X₁₋(f) and X₂₋(f), respectively. The bands of X₁₋(f), X₁₊(f), X₂₋(f), and X₂₊(f) are each about f_{c}. A relationship of the following formulae holds between the positive frequency components and the shifted negative frequency components, and the complex drive signals X₁(f) and X₂(f).

$$\begin{matrix}[ Math . 5 ] & \\ {X}_{1} ( f ) = {X}_{1 -} ( f + {f}_{c} ) + {X}_{1 +} ( f ) & Formula ( 5 a )\end{matrix}$$

$${X}_{2} ( f ) = {X}_{2 -} ( f + {f}_{c} ) + {X}_{2 +} ( f ) \qquad Formula ( 5 b )$$

In the above formulae, it can be understood that the complex drive signals X₁(f) and X₂(f) to the two IQ modulation units are expressed by signals obtained by decomposing the complex drive signals X₁(f) and X₂(f) into signal components of the band B of about f_{c}, respectively, and decomposing and shifting the signal components.

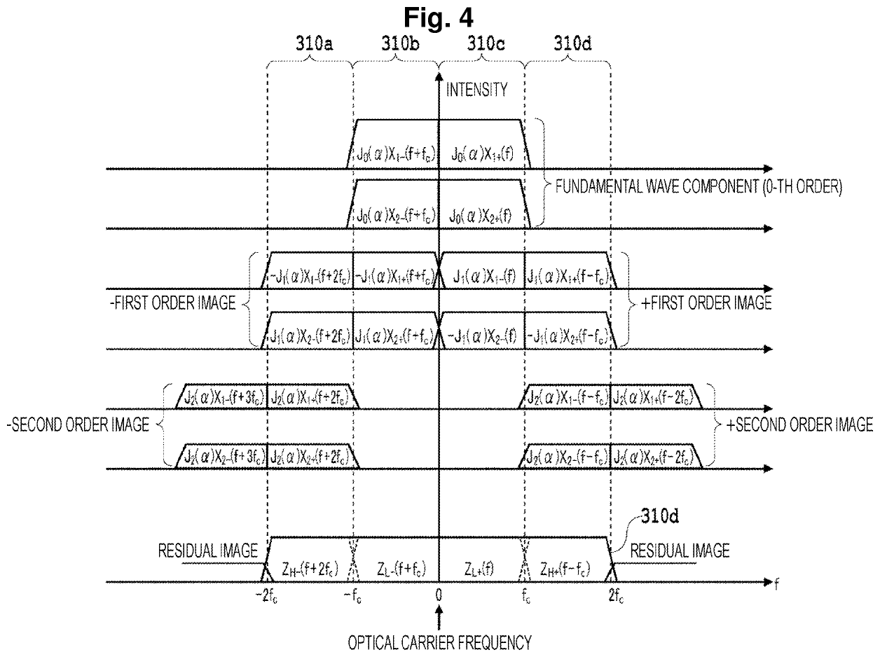

FIG. 4 is a diagram illustrating a relationship between components when the received optical signal Z(f) is decomposed into narrower bands. That is, the relationship between the decomposed and shifted Z_{H-}(f), Z_{L-}(f), Z_{L+}(f), and Z_{H+}(f) of the received optical signal Z(f) and the decomposed and shifted complex drive signals X₁₋(f), X₁₊(f), X₂₋(f), and X₂₊(f) is illustrated. In FIG. 4, the optical signal Z(f) includes an important spectrum in the four bands 310a to 310d, and in each band, four components of the fundamental wave component, the first-order image, and the secondary image overlap each other. Further, in the spectrum of the optical signal Z(f), for example, the spectrum of the band 310a is expressed as Z_{H-}(f+2f_{c}), which is because the signal in the band 310c after the spectrum of the band 310a is frequency-shifted is defined as Z_{H-}(f). Therefore, the spectrum originally in the band 310a is obtained by shifting Z_{H-}(f) by +2f_{c} in the negative frequency direction, and is expressed as Z_{H-}(f+2f_{c}) as illustrated by a spectrum 304 in FIG. 4. Therefore, if Z_{H-}(f) is obtained, it means that the spectrum of the band 310a, which is the original frequency position, can be reproduced by performing processing of shifting Z_{H-}(f) by +2f_{c} in the negative frequency direction. The same applies to all the other decomposed spectra illustrated in FIG. 4.

As can be seen from FIG. 4 and Formula (4), the following relationship holds.

$$\begin{matrix}[ Math . 6 ] & \\ {Z}_{H -} ( f ) = {J}_{1} ( α ) \{ - {X}_{1 -} ( f ) + {X}_{2 -} ( f ) \} + {J}_{2} ( α ) \{ {X}_{1 +} ( f ) + {X}_{2 +} ( f ) \} & Formula ( 6 a )\end{matrix}$$

$${Z}_{L -} ( f ) = {J}_{0} ( α ) \{ {X}_{1 -} ( f ) + {X}_{2 -} ( f ) \} + {J}_{1} ( α ) \{ - {X}_{1 +} ( f ) + {X}_{2 +} ( f ) \} \qquad Formula ( 6 b )$$

$${Z}_{L +} ( f ) = {J}_{0} ( α ) \{ {X}_{1 +} ( f ) + {X}_{2 +} ( f ) \} + {J}_{1} ( α ) \{ {X}_{1 -} ( f ) - {X}_{2 -} ( f ) \} \qquad Formula ( 6 c )$$

$${Z}_{H +} ( f ) = {J}_{1} ( α ) \{ {X}_{1 +} ( f ) - {X}_{2 +} ( f ) \} + {J}_{2} ( α ) \{ {X}_{1 -} ( f ) + {X}_{2 -} ( f ) \} \qquad Formula ( 6 d )$$

Formulae (6a) to (6d) above are expressed in a matrix form as follows.

$$\begin{matrix}[ Math . 7 ] & \\ ( \begin{matrix}{Z}_{H -} ( f ) \\ {Z}_{L -} ( f ) \\ {Z}_{L +} ( f ) \\ {Z}_{H +} ( f )\end{matrix} ) = ( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} ) ( \begin{matrix}{X}_{1 -} ( f ) \\ {X}_{1 +} ( f ) \\ {X}_{2 -} ( f ) \\ {X}_{2 +} ( f )\end{matrix} ) & Formula ( 7 )\end{matrix}$$

For the 4×4 matrix on the right side of the above Formula (7), a determinant (det) that is an index for determining the reversibility of the matrix is obtained as the following formula.

$$\begin{matrix}[ Math . 8 ] & \\ ( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} ) = - 4 [ {\{ {J}_{0} ( α ) \}}^{2} {\{ {J}_{1} ( α ) \}}^{2} + 2 {J}_{0} ( α ) {\{ {J}_{1} ( α ) \}}^{2} {J}_{2} ( α ) + {\{ {J}_{1} ( α ) \}}^{2} {\{ {J}_{2} ( α ) \}}^{2} ] & Formula ( 8 )\end{matrix}$$

When the value of the determinant of Formula (8) is non-zero, an inverse matrix exists in the 4×4 matrix on the right side of Formula (7). When the value of the determinant is actually calculated, the value of the determinant of Formula (8) is non-zero if at least 0<α<1.2π for the parameter α representing the drive amplitude described in Formulae (3a) and (3b).

Therefore, if at least 0<α<1.2 π, X₁₋(f), X₁₊(f), X₂₋(f), and X₂₊(f) can be obtained from Z_{H-}(f), Z_{L-}(f), Z_{L+}(f), and Z_{H+}(f) by the following formula.

$$\begin{matrix}[ Math . 9 ] & \\ ( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} ) & Formula ( 9 )\end{matrix}$$

If X₁₋(f), X₁₊(f), X₂₋(f), and X₂₊(f), which are components of the decomposed and shifted drive signals, are obtained by Formula (9), X₁(f) and X₂(f) can be further obtained by Formula (5). That is, the complex drive signal input to the two IQ modulation units can be obtained by the optical modulation circuit from the optical signal Z(f) received on the reception side by a series of signal processing and the above-described Formula (9).

A series of processing and calculations including band division, frequency shift, and the like in the above Formulae (1) to (9) can be performed using the DSP on the reception side. That is, first, Z(f) is obtained by compensating for the influence of the response characteristics of the transmission path and the receiver from the received digital waveform. Z(f) is divided into approximately each frequency band f_{c} as described above, and the divided Z(f) is shifted to the baseband to obtain Z_{H-}(f), Z_{L-}(f), Z_{L+}(f), and Z_{H+}(f). By using the above Formulae (9), (5a), and (5b), X₁(f) and X₂(f), which are drive complex signals of the IQ modulation units 261-1 and 261-2 on the transmission side, can be obtained.

Therefore, the present invention can be implemented as a signal processing method used in a receiver that receives a transmission signal from an optical transmitter including the optical modulation circuit described above, the signal processing method including: a step of dividing a received complex signal having a bandwidth less than 4f_{c} around a carrier frequency on a frequency axis into four bands approximately for each width f_{c}; a step of generating four digital divided signals corresponding to signals obtained by frequency-shifting a spectrum of the divided bands to baseband (0 to +f_{c}); and a step of calculating complex signal spectra X₁(f) and X₂(f) provided by one IQ modulation unit or one sub-IQ modulation unit based on the Formulae (9), (5a), and (5b), where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.

In this way, in the optical modulation circuit 200 of FIG. 2, the two optical waves differentially phase-modulated into opposite signs at the frequency f_{c} are used as drive optical signals to the corresponding IQ modulation units, and the IQ modulation units perform modulation with X₁(f) and X₂(f), and the spectrum Z(f) of the output optical signal 202 is transmitted. The received Z(f) is divided into the same band B as the frequency f_{c}, and X₁(f) and X₂(f) can be reproduced by a series of processing and calculations of the above Formulae (1) to (9). With the simplified optical modulation circuit 200 as illustrated in FIG. 2, it is possible to achieve large-capacity transmission equivalent to that of the optical interleaving technology in FIG. 1, and at the same time, it is possible to achieve reduction in overall size and loss of the optical modulation circuit and relaxation of conditions of design and manufacturing processes.

A series of processing and calculations including the band division, the frequency shift, and the like in the above Formulae (1) to (9) can also be implemented in the DSP on the transmission side for generation of the transmission signal of the optical transmitter. It is assumed that a desired modulated optical waveform to be generated as an output signal of the optical transmitter is a desired Z(f) to be expressed as a digital waveform. The spectrum of Z(f) is divided into approximately each frequency band f_{c} as described above, and is frequency-shifted to the baseband of 0 to +f_{c} (band 310c). As a result of this spectrum division and frequency shift processing, Z_{H-}(f), Z_{L-}(f), Z_{L+}(f), and Z_{H+}(f) are obtained. The complex signals X₁(f) and X₂(f) are calculated by using Formula (9) and Formulae (5a) and (5b), and transmitted to the DAC that drives the IQ modulation units 261-1 and 261-2, so that the output optical signal Z(f) of the optical modulation circuit 200 is obtained.

An optical waveform having a desired spectrum Z(f) as components of frequencies −2f_{c} to +2f_{c} can be obtained in the spectrum of the output optical signal Z(f). Note that, in this case, the waveforms to be transmitted to the DAC are waveforms corresponding to the real part and the imaginary part of each of the complex signals X₁(f) and X₂(f) in Formulae (1a) and (1b). In this way, assuming a desired spectrum Z(f) of arbitrary modulated light with respect to the carrier optical wave transmitted from the optical transmitter, it means that the complex signals X₁(f) and X₂(f) to be transmitted to the DAC can be uniquely specified in order to achieve the desired spectrum Z(f). In other words, modulated light having an arbitrary waveform with respect to carrier light can be output. The processing procedure of the series of spectrum operations from the above Formulae (1) to (9) has aspects as not only signal processing in the receiver of the transmission signal from the optical modulation circuit of the present disclosure but also generation processing of an arbitrary light wave. The reproduction in the receiver of the optical wave generated by the complex signals X₁(f) and X₂(f) on the transmission side and the generation of an arbitrary desired spectral Z(f) optical wave in the transmitter by the complex signals X₁(f) and X₂(f) are common as the processing of the digital domain including the convolution operation.

As described above, if the parameter α representing the amplitude of the drive signal from the differential optical phase modulation unit to the IQ modulation unit satisfies at least 0<α<1.2 n, the information of X₁(f) (band 2B) and the information of X₂(f) (band 2B) can be transmitted by transmitting the components (band 4B) of the frequencies −2f_{c} to +2f_{c} of Z(f). By using the present optical modulation circuit 200, it is possible to transmit information in a band that is about twice of that in a case where any one of the IQ modulation circuits 261-1 and 261-2 is used alone. Even if the bandwidth of the DAC is about f_{c} and is insufficient, it is possible to achieve reduction in size and loss of the optical modulation circuit and relaxation of conditions of design and manufacturing processes by achieving a large-capacity equivalent to that of the optical interleaving technology and at the same time, simplifying the circuit configuration.

### Second Embodiment

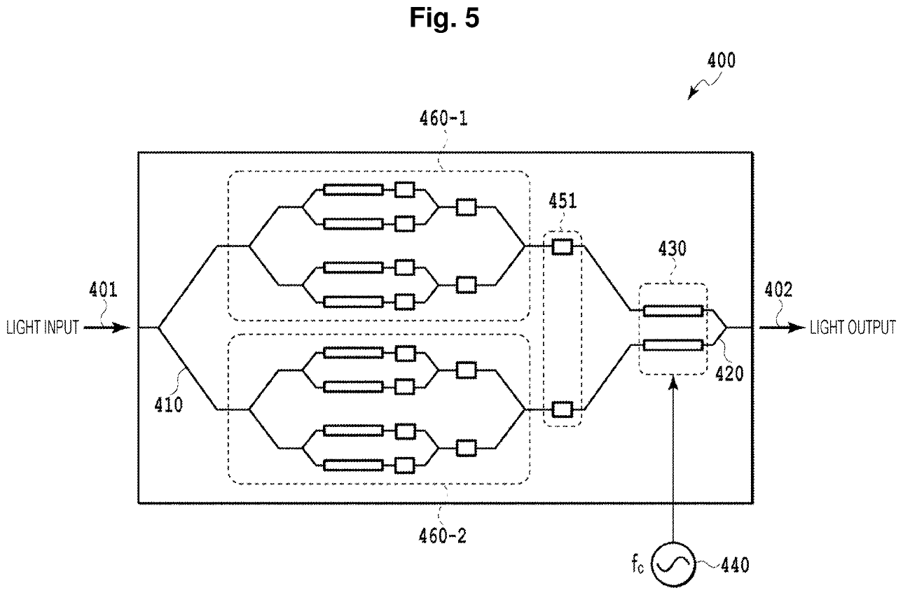

FIG. 5 is a diagram schematically illustrating a configuration of an optical modulation circuit of a second embodiment. An optical modulation circuit 400 is obtained by integrating an input-side coupler 410, IQ modulation units 460-1 and 460-2, a phase adjustment unit 451, a differential optical phase modulation unit 430, and an output-side coupler 420. The difference from the optical modulation circuit 200 illustrated in FIG. 2 is that the connection order of the IQ modulation unit, the phase adjustment unit, and the differential optical phase modulation unit is changed, and the function thereof is completely equivalent to that of the optical modulation circuit 200. As shown in the above Formula (2), a spectrum X₁(f) of the output complex signal from the IQ modulation unit 460-1 is convolved with S₁(f), and a spectrum X₂(f) of the output complex signal from the IQ modulation unit 460-2 is convolved with S₂(f). Since the convolution operation is not related to the order of the components, convolution of the modulation output of the IQ modulation unit 460-1 and one drive signal of the differential optical phase modulation unit 430, and convolution of the modulation output of the IQ modulation unit 460-2 and the other drive signal of the differential optical phase modulation unit 430 are equivalently performed. The two convolution signals are added at the output-side coupler 420 to obtain an output optical signal 402.

The differential optical phase modulation unit 430 of the optical modulation circuit 400 applies phase modulation of opposite signs to each other to two internal optical paths. As the differential optical phase modulation unit 430, the same structure as a phase modulation arm of a push-pull Mach-Zehnder modulator which is a component of a general optical IQ modulator can be used. An optical path length difference between an optical path from the input-side coupler 410 to the output-side coupler 420 via the IQ modulation unit 460-1 and an optical path from the input-side coupler 410 to the output-side coupler 420 via the IQ modulation unit 460-2 is zero.

By modulating the two IQ modulation units with independent information signals, it is possible to perform modulation with a signal of a band that is twice the bandwidth possible with a single IQ modulation unit. The optical modulation circuit 400 is a single polarization modulation circuit not having a polarization multiplexing function using one input light beam 401 as a carrier.

Also in the optical modulation circuit of the present embodiment, similarly to the first embodiment, the phase adjustment unit in the differential optical phase modulation unit 430 is unnecessary, and the 2×2 coupler having the configuration of the related art in FIG. 1 is also unnecessary. Similarly to the first embodiment, it is possible to achieve reduction in overall size and loss of the optical modulation circuit and relaxation of conditions of design and manufacturing processes.

### Third Embodiment

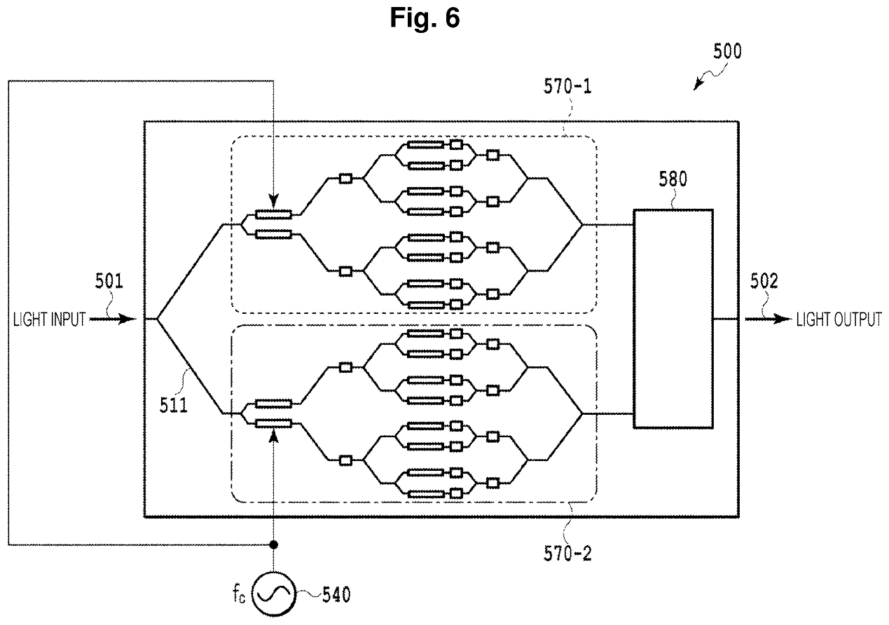

FIG. 6 is a diagram schematically illustrating a configuration of an optical modulation circuit of a third embodiment. An optical modulation circuit 500 is a polarization multiplexing modulation circuit obtained by simply parallelizing two optical modulation circuits 200 of the first embodiment illustrated in FIG. 2. Sub-optical modulation circuits 570-1 and 570-2 are circuits equivalent to the optical modulation circuit 200 illustrated in FIG. 2, respectively. Two sub-optical modulation circuits are arranged between a branch coupler 511 and an orthogonal polarization coupling unit 580, and input light 501 is split and supplied to each sub-optical modulation circuit, so that two sub-optical modulation circuits parallelized. Similarly to the orthogonal polarization coupling unit of a general polarization multiplexing IQ modulator, the orthogonal polarization coupling unit 580 may have a configuration in which polarization of one input is rotated by 90 degrees and then coupled by a polarization beam combiner.

The differential optical phase modulation unit of each of the sub-optical modulation circuits 570-1 and 570-2 is driven by a sine wave signal having a frequency f_{c} emitted from a periodic signal source 540. As illustrated in FIG. 6, by employing a configuration in which two similar optical modulation circuits 200 are parallelized, the optical modulation circuit 200 illustrated in FIG. 2 can be extended for polarization multiplexing modulation.

### Fourth Embodiment

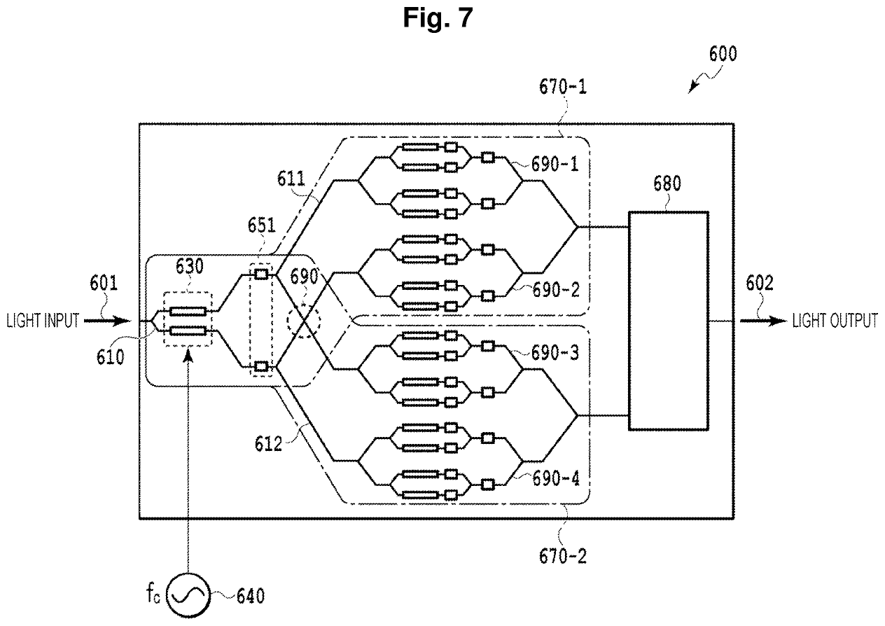

FIG. 7 is a diagram schematically illustrating a configuration of an optical modulation circuit according to a fourth embodiment. An optical modulation circuit 600 achieves a function equivalent to that of the optical modulation circuit 500 for polarization multiplexing modulation of the third embodiment illustrated in FIG. 6 with a simpler configuration. Sub-optical modulation circuits 670-1 and 670-2 are circuits equivalent to the IQ modulation unit of the optical modulation circuit 200 illustrated in FIG. 2, respectively. That is, a first sub-optical modulation circuit 670-1 includes IQ modulation units 690-1 and 690-2, and a second sub-optical modulation circuit 670-2 includes IQ modulation units 690-3 and 690-4. The difference from the third embodiment is that an input-side coupler 610, a differential optical phase modulation unit 630, and a phase adjustment unit 651 are shared by the two sub-optical modulation circuits 670-1 and 670-2. For this configuration, two outputs of the phase adjustment unit 651 are connected to corresponding IQ modulation units of the two sub-optical modulation circuits by branch couplers 611 and 612, respectively.

Specifically, one output of the differential optical phase modulation unit 630 is connected to the IQ modulation unit 690-1 of the first sub-optical modulation circuit 670-1 and the IQ modulation unit 690-3 of the second sub-optical modulation circuit 670-2 by the branch coupler 611. Similarly, the other output of the differential optical phase modulation unit 630 is connected to the IQ modulation unit 690-2 of the first sub-optical modulation circuit 670-1 and the IQ modulation unit 690-4 of the second sub-optical modulation circuit 670-2 by the branch coupler 612. The four IQ modulation units are equivalently arranged in the order of the IQ modulation units 690-1, 690-2, 690-3, and 690-4 in a direction orthogonal to the light traveling direction of the optical modulation circuit. Here, the orthogonal direction means a direction substantially orthogonal to the arm waveguide of the IQ modulation unit of the optical modulation circuit. From the symmetry of the two sub-optical modulation circuits, it is preferable that the four IQ modulators be regularly arranged in a line at equal intervals, but the arrangement is not limited to that in FIG. 7 as long as the symmetry of the entire two optical paths after the input-side coupler 610 in the optical modulation circuit and the symmetry of the optical path length between the two sub-optical modulation circuits are maintained. It should be noted that all the drawings in this application schematically illustrate functions and connection relationships of optical circuit elements, and do not illustrate a layout pattern of circuit elements on an actual substrate.

In other words, two IQ modulation units are arranged adjacent to each other in the sub-optical modulation circuit of one polarization. As a result, a waveguide intersection 691 is required on the input side of the two sub-optical modulation circuits, but the number of circuit elements is small as a whole, and a more simplified configuration is obtained as compared with the optical modulation circuit 500 of the third embodiment illustrated in FIG. 6.

Therefore, the optical modulation circuit according to the present embodiment can be implemented as an optical modulation circuit including: the input-side coupler 610 that splits input light; the differential optical phase modulation unit 630 that differentially modulates a phase of each optical wave from the input-side coupler with a periodic signal having a frequency f_{c}; the first coupler 611 that splits a first modulated optical wave of the differential optical phase modulation unit; the second coupler 612 that splits a second modulated optical wave of the differential optical phase modulation unit; the first sub-optical modulation circuit 670-1 to which one split light from the first coupler and one split light from the second coupler are input; the second sub-optical modulation circuit 670-2 to which the other split light from the first coupler and the other split light from the second coupler are input; and the orthogonal polarization coupler 680 that couples the first sub-optical modulation circuit and the second sub-optical modulation circuit.

Sharing the differential optical phase modulation unit 630 between the two sub-optical modulation circuits not only reduces the circuit occupied area but also can reduce the number of wirings and drivers of the drive system, so that the effect of simplification is large. At the subsequent stage of the phase adjustment unit 651, the optical waves are distributed toward the IQ modulation unit of each polarization channel by the branch couplers 611 and 612, and finally, polarization multiplexing is performed by the orthogonal polarization coupling unit 680. Similarly to the orthogonal polarization coupling unit of a general polarization multiplexing IQ modulator, the orthogonal polarization coupling unit 680 may have a configuration in which polarization of one input is rotated by 90 degrees and then coupled by a polarization beam combiner.

### Fifth Embodiment

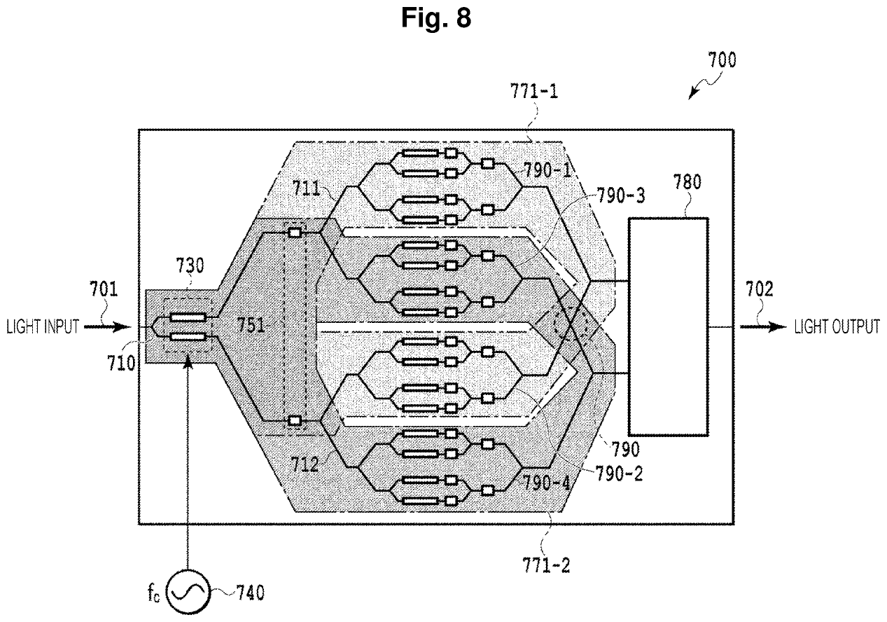

FIG. 8 is a diagram schematically illustrating a configuration of an optical modulation circuit according to a fifth embodiment. An optical modulation circuit 700 also achieves a function equivalent to that of the optical modulation circuit 500 for polarization multiplexing modulation of the third embodiment illustrated in FIG. 5 with a simpler configuration. Sub-optical modulation circuits 771-1 and 771-1 are circuits equivalent to the optical modulation circuit 200 illustrated in FIG. 2, respectively. The difference from the third embodiment is that an input-side coupler 710, a differential optical phase modulation unit 730, and a phase adjustment unit 751 are shared by the two sub-optical modulation circuits 771-1 and 771-1. The present embodiment is the same as the optical modulation circuit 600 of the fourth embodiment illustrated in FIG. 7 in that the two sub-optical modulation circuits share an element on a front stage side.

Similarly to the fourth embodiment, two outputs of the phase adjustment unit 751 are connected to the corresponding IQ modulation units of the two sub-optical modulation circuits by branch couplers 711 and 712, respectively. Specifically, one output of the differential optical phase modulation unit 730 is connected to an IQ modulation unit 790-1 of a first sub-optical modulation circuit 770-1 and an IQ modulation unit 790-3 of a second sub-optical modulation circuit 770-2 by the branch coupler 711. Similarly, the other output of the differential optical phase modulation unit 730 is connected to an IQ modulation unit 790-2 of the first sub-optical modulation circuit 770-1 and an IQ modulation unit 790-4 of the second sub-optical modulation circuit 770-2 by the branch coupler 712.

The four IQ modulation units are equivalently arranged in the order of the IQ modulation units 790-1, 790-3, 790-2, and 790-4 in a direction orthogonal to the light traveling direction of the optical modulation circuit. In other words, the IQ modulation units of the sub-optical modulation circuits of different polarizations are alternately arranged. The only difference from the configuration of the fourth embodiment is that the arrangement of the IQ modulation units in each sub-optical modulation circuit is staggered (nested), and thus a waveguide intersection 791 is present on the output side of the sub-optical modulation circuit. Therefore, in the fourth and fifth embodiments, the number of circuit elements and the overall function are completely equivalent.

For the configuration of FIG. 7, the waveguide intersection 791 is required on the output side of the two sub-optical modulation circuits, but the number of circuit elements is small as a whole and a simplified configuration is obtained as compared with the optical modulation circuit 500 of the third embodiment illustrated in FIG. 6.

Sharing the differential optical phase modulation unit 730 not only reduces the circuit occupied area but also can reduce the number of wirings and drivers of the drive system, so that the effect of simplification is large. At the subsequent stage of the phase adjustment unit 751, the optical waves are distributed toward the sub-optical modulation circuits of the respective polarization channels by the branch couplers 711 and 712, respectively, and the two IQ modulation units of the respective sub-optical modulation circuits achieve a large capacity equivalent to that of the optical interleaving technology similarly to the first embodiment. Finally, polarization multiplexing is performed by an orthogonal polarization coupling unit 780. Similarly to the orthogonal polarization coupling unit of a general polarization multiplexing IQ modulator, the orthogonal polarization coupling unit 780 may have a configuration in which polarization of one input is rotated by 90 degrees and then coupled by a polarization beam combiner.

In any of the fourth and fifth embodiments having the above-described polarization n multiplexed configuration, the drive frequency f_{c} of the differential optical phase modulation unit is set to be about the same as the band B of the drive signal to the IQ modulation unit in each sub-optical modulation circuit. By setting the band of the drive signal to the IQ modulation unit and the drive frequency f_{c} of the differential optical phase modulation unit to be about the same, the drive complex signals X₁(f) and X₂(f) of the IQ modulation unit on the transmission side can be reproduced by a series of processing and calculations of Formulae (1) to (9) described above on the reception side. Similarly to the first embodiment, the phase adjustment unit of the differential optical phase modulation unit is unnecessary, and the 2×2 coupler having the configuration of the related art is also unnecessary. Similarly to the first embodiment, it is possible to extend the configuration to a configuration in which polarization multiplexing is performed while achieving reduction in overall size and loss of the optical modulation circuit and relaxation conditions of design and manufacturing processes.

As described above in detail, the optical modulation circuit of the present disclosure achieves bandwidth extension about twice that in a case where the IQ modulation unit is used alone as in the related art while having a simpler optical circuit configuration than that in the related art. Reduction in overall size and loss of the optical modulation circuit and relaxation of conditions of design and manufacturing processes are achieved.

### INDUSTRIAL APPLICABILITY

The present invention can be used for optical communication and an optical transmitter.

1. An optical modulation circuit comprising:
an input-side coupler that splits input light;
an output-side coupler that couples a first optical path and a second optical path branched from the input-side coupler;
a differential optical phase modulation unit that modulates phases of respective optical waves of the first optical path and the second optical path with a periodic signal having a frequency f_{c}; and
a first IQ modulation unit arranged on the first optical path and a second IQ modulation unit arranged on the second optical path.

2. The optical modulation circuit according to claim 1, wherein the optical wave of the first optical path and the optical wave of the second optical path from the differential optical phase modulation unit are phase-modulated with opposite signs.

3. The optical modulation circuit according to claim 1, further comprising a phase adjustment unit that performs adjustment such that optical phases of the respective optical waves of the first optical path and the second optical path coincide with each other.

4. The optical modulation circuit according to claim 1, wherein the phase-modulated optical wave from the differential optical phase modulation unit is applied to the first IQ modulation unit and the first IQ modulation unit.

5. The optical modulation circuit according to claim 1, wherein each modulated light beam from the first IQ modulation unit and the second IQ modulation unit is applied to the differential optical phase modulation unit.

6. An optical modulation circuit comprising:
an input-side coupler that splits input light;
a differential optical phase modulation unit that differentially modulates a phase of each optical wave from the input-side coupler with a periodic signal having a frequency fc;
a first coupler that splits a first modulated optical wave of the differential optical phase modulation unit;
a second coupler that splits a second modulated optical wave of the differential optical phase modulation unit;
a first sub-optical modulation circuit to which one split light from the first coupler and one split light from the second coupler are input;
a second sub-optical modulation circuit to which the other split light from the first coupler and the other split light from the second coupler are input; and
an orthogonal polarization coupler that couples the first sub-optical modulation circuit and the second sub-optical modulation circuit.

7. The optical modulation circuit according to claim 6,
wherein the first sub-optical modulation circuit includes a first IQ modulation unit and a second IQ modulation unit,
the second sub-optical modulation circuit includes a third IQ modulation unit and a fourth IQ modulation unit,
the first IQ modulation unit, the second IQ modulation unit, the third IQ modulation unit, and the fourth IQ modulation unit are arranged in that order in a direction orthogonal to a traveling direction of light, and there is an intersection of waveguides on input sides of the first sub-optical modulation circuit and the second sub-optical modulation circuit, or
the first IQ modulation unit, the third IQ modulation unit, the second IQ modulation unit, and the fourth IQ modulation unit are arranged in that order in the orthogonal direction, and there is an intersection of waveguides on output sides of the first sub-optical modulation circuit and the second sub-optical modulation circuit.

8. A signal processing method used in a receiver that receives a transmission signal from an optical transmitter including the optical modulation circuit according to claim 1, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where α is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

9. The optical modulation circuit according to claim 2, wherein the phase-modulated optical wave from the differential optical phase modulation unit is applied to the first IQ modulation unit and the first IQ modulation unit.

10. The optical modulation circuit according to claim 3, wherein the phase-modulated optical wave from the differential optical phase modulation unit is applied to the first IQ modulation unit and the first IQ modulation unit.

11. The optical modulation circuit according to claim 2, wherein each modulated light beam from the first IQ modulation unit and the second IQ modulation unit is applied to the differential optical phase modulation unit.

12. The optical modulation circuit according to claim 3, wherein each modulated light beam from the first IQ modulation unit and the second IQ modulation unit is applied to the differential optical phase modulation unit.

13. A signal processing method used in a receiver that receives a transmission signal from an optical transmitter including the optical modulation circuit according to claim 2, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

14. A signal processing method used in a receiver that receives a transmission signal from an optical transmitter including the optical modulation circuit according to claim 3, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

15. A signal processing method used in a receiver that receives a transmission signal from an optical transmitter including the optical modulation circuit according to claim 4, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

16. A signal processing method used in a receiver that receives a transmission signal from an optical transmitter including the optical modulation circuit according to claim 5, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

17. A signal processing method used in a receiver that receives a transmission signal from an optical transmitter including the optical modulation circuit according to claim 6, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$

18. A signal processing method used in a receiver that receives a transmission signal from an optical transmitter including the optical modulation circuit according to claim 7, the signal processing method comprising:
a step of dividing a received complex signal having a bandwidth less than 4f_{c} around a carrier frequency on a frequency axis into four bands approximately for each width f_{c};
a step of generating four digital divided signals corresponding to signals obtained by frequency-shifting a spectrum of the divided bands to baseband (0 to +f_{c}); and
a step of calculating complex signal spectra X₁(f) and X₂(f) provided by one IQ modulation unit or one sub-IQ modulation unit based on the following formulae, where a is a value obtained by multiplying π/4 by a value obtained by dividing a drive amplitude (peak-to-peak) applied to two arm waveguides of the differential optical phase modulation unit by a half wavelength voltage, Jₙ is a Bessel function of a first kind with order n, and spectra of the four digital divided signals are set as Z_{H-}(f), Z_{L-}(f), Z_{L+}(f), and Z_{H+}(f) from a low frequency side.
$$( \begin{matrix}{X}_{1 -} ( f ) \\ {X}_{1 +} ( f ) \\ {X}_{2 -} ( f ) \\ {X}_{2 +} ( f )\end{matrix} ) = {( \begin{matrix}- {J}_{1} ( α ) & {J}_{2} ( α ) & {J}_{1} ( α ) & {J}_{2} ( α ) \\ {J}_{0} ( α ) & - {J}_{1} ( α ) & {J}_{0} ( α ) & {J}_{1} ( α ) \\ {J}_{1} ( α ) & {J}_{0} ( α ) & - {J}_{1} ( α ) & {J}_{0} ( α ) \\ {J}_{2} ( α ) & {J}_{1} ( α ) & {J}_{2} ( α ) & - {J}_{1} ( α )\end{matrix} )}^{- 1} ( \begin{matrix}{Z}_{H -} ( f ) \\ {Z}_{L -} ( f ) \\ {Z}_{L +} ( f ) \\ {Z}_{H +} ( f )\end{matrix} )$$
$${x}_{1} ( f ) = {x}_{1 -} ( f + {f}_{c} ) + {x}_{1 +} ( f )$$
$${x}_{2} ( f ) = {x}_{2 -} ( f + {f}_{c} ) + {x}_{2 +} ( f )$$
